(19) United States
(12) Patent Application Publication
(10) Pub. No.: US 2006/0133387 A1
(43) Pub. Date: Jun. 22, 2006

(54) Route tracing in wireless networks

(76) Inventors: Georgiy Pekhteryev, Maynard, MA (US); Zafer Sahinoglu, Somerville, MA (US)

Correspondence Address: Patent Department;Mitsubishi Electric Research Laboratories, Inc., 201 Broadway, Cambridge, MA, 02139, US

(21) Appl. No.: 11/014,151

(22) Filed: Dec. 16, 2004

(51) Int. Cl. H04L 12/56; H04L 12/28

(52) U.S. Cl. 370/400

(57) ABSTRACT

A method traces a route in a wireless network including nodes. A trace packet is generated in a tracer node. The trace packet includes addresses of a source node and a destination node in a route. The trace packet is sent from the tracer node to the source node, and then along the route to the destination node. In response to receiving the trace packet in each node along the route, a report packet is sent to the tracer node.

### FIELD OF THE INVENTION

The present invention relates generally to wireless networks, and more particularly to tracing routes in wireless networks.

### BACKGROUND OF THE INVENTION

In general, a wireless network includes a single coordinator node and many other nodes. The nodes exchange data using packets. The packets include source and destination addresses that define routes traveled by the packets. It is desired to ‘trace’ routes for fault detection and network operation management purposes. Route information can be used for detecting faulty nodes, optimizing routes, increasing reliability, and decreasing required resources. The current invention distinguishes itself from conventional trace-routing protocol developed for wired and IP networks, because the invention develops a method for tracing already established routes in wireless networks.

In U.S. Patent Application Pub. No. 20040199627, methods and products for carrying out fault diagnosis in a network are described. A route between a monitoring station and a monitored device is traced and stored. In response to an apparent fault of the monitored device, at least one request to a device or devices along the stored route is sent.

U.S. Patent Application Pub. No. 20040052239 describes a method for determining a preferred route using a computer-implemented routing system. The method uses a routing system to access an origin and a destination in a routing graph representing a network of roads. The graph includes two or more nodes and one or more links. Each link represents a road, and each node represents an intersection that includes at least one road. The system can be used to determine a preferred route from the origin to the destination based at least in part upon an intersection cost for at least one intersection in the routing graph.

In U.S. Patent Application Pub. No. 20040044465, an automated route determination is based on day of route traversal. A preferred route is determined from an origin location to a destination location. The determination is made by processing directed links, e.g., one-way edges, in a graph that includes one or more links and two or more nodes. The determination of the preferred route may include an estimate of the time required at one or more intersections along alternative routes and/or an estimate of the time required to travel the alternative routes based on the day of the week or the day of the year in which travel occurs.

In U.S. Patent Application Pub. No. 20020131367, a dichotomy-based method for tracing a route between an origin node and a target node in a TCP/IP data network. The method sends a succession of messages in a dichotomy-based manner. The origin node sends a message to the target node, with a ‘time to live’ equal to an intermediate value between the start and end distances.

In U.S. Patent Application Pub. No. 20040034714, a method for determining a route through a managed network using Internet Protocol is described. A network management station can use a source-routed IP route tracing operation to determine a packet transmission route for a managed network even when an end-station from which the packet emanates (source node) in the managed network does not support source-routed IP route tracing operation.

In U.S. Patent Application Pub. No. 20030225906, a method of finding a route between two nodes in a network is described. That method finds a route between two nodes, including the routing and non-routing nodes of the route. The method obtains information from a routing table of a first node in the route to determine a second node in the route.

### SUMMARY OF THE INVENTION

The invention traces a route from a source node to a destination node in a wireless network by generating a ‘trace’ packet in a tracing node, such as a coordinator node. The trace packet has addresses of the source node and the destination node.

The trace packet is transmitted to the source node, which in response generates a report packet for the tracing node. The trace packet is forwarded from the source node to the destination node via intermediate nodes along the route.

Each node along the route generates a report packet for the tracing node. When the trace node reaches the destination node, the final report from the destination node back to the tracing node confirms the entire route.

### BRIEF DESCRIPTION OF THE DRAWINGS

FIG. 1 is a diagram of a wireless network according to the invention.

### DETAILED DESCRIPTION OF THE PREFERRED EMBODIMENT

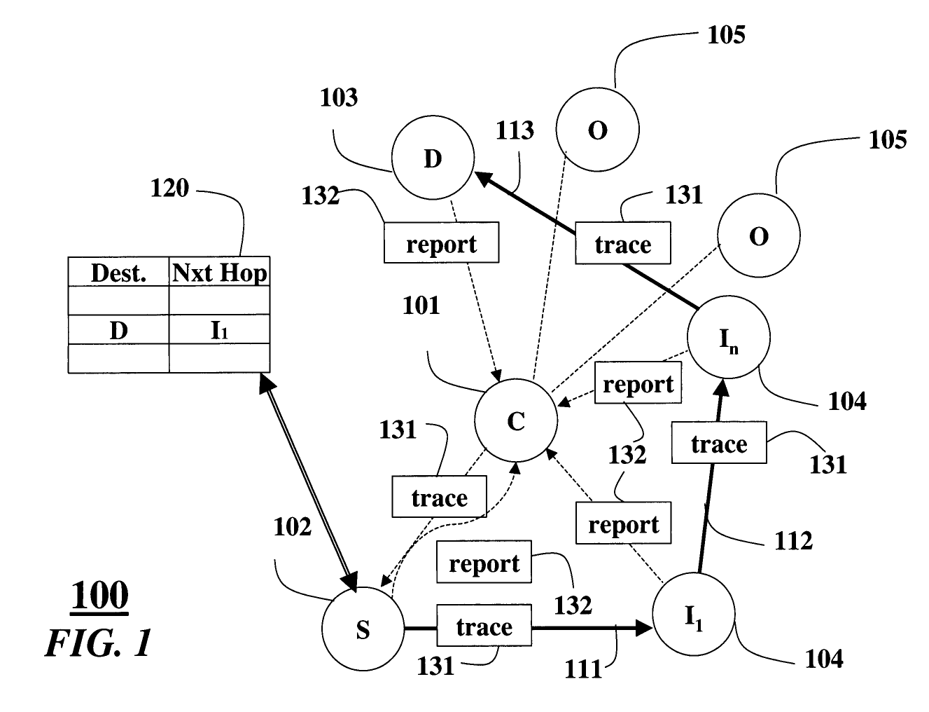

The present invention provides a method for tracing a route in a wireless network 100 as shown in FIG. 1. The network includes a coordinator node (C) 101, a source node (S) 102, a destination node (D) 103, optimal intermediate nodes (I₁, . . . , Iₙ) 104, and other nodes (O) 105. Bold and dashed lines indicate wireless links between the nodes. Wireless links, indicated by line segments 111-113, form a ‘route’ from the source node 101 to the destination node 102.

Each node maintains a routing table 120. Entries in the routing table of a node, e.g., the source node S, are comprised of the address of a destination node, e.g., D, and an address of a next hop node, e.g., I₁, to reach the destination D.

Hence, every node knows a-priori to which node to forward received packets until the packet reaches its destination. The trace-route technique assumes that this a-priori routing information is prestored in the routing tables of various nodes, e.g., the source, destination and intermediate nodes.

The method according to the invention traces an already established route from a source node to a destination node. In the first step, a tracer node, e.g., C, generates a ‘trace’ packet 131. The trace packet includes an address of the source node, e.g., S, and an address of the destination node, e.g., D, selected by the ‘tracer’ node, e.g., the coordinator node C 101.

The next step transmits the trace packet 131 to the source node S, 101. In response to receiving the trace packet, the source node, 101, sends a ‘report’ packet 132 to the tracing node.

The report packet carries the address of the next hop node, e.g., I₁, towards the destination, 103. The source node extracts the next hop address from its routing table. The information in the report packet can include link quality, bit rate, packet loss rate, bit error rate, average and minimum and maximum delay.

The source node passes the trace packet 131 to the destination node via intermediate nodes 104, along the route 111-113. Each intermediate node along the route sends a separate report packet 132 back to the tracing node. The destination node, 103, sends a final report packet 134 back to the tracing node, 101, to indicate that the route tracing has completed.

From each report packet that arrives at the tracer node, e.g., the coordinator node, the tracer node can determine what other nodes should be sending report because the address of the next node in the route is included in the report.

If the tracer node does not receive a report from a node, then the tracer node can communicate with that node directly to determine whether the node failing to report is operating correctly.

After the tracing completes, the route from the source 102 to the destination 103 is confirmed. The trace information can be presented to a user of the network.

The invention is designed to minimize tracing communication overhead.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for tracing a route in a wireless network including a plurality of nodes, comprising:
generating a trace packet in a tracer node, the trace packet including addresses of a source node and a destination node in a route;
sending the trace packet from the tracer node to the source node and then along the route to the destination node; and
sending, in response to receiving the trace packet in each node along the route, a report packet to the tracer node.

2. The method of claim 1, in which the tracer node is a coordinator node.

3. The method of claim 1, in which the route includes intermediate nodes between the source node and the destination node.

4. The method of claim 1, in which the report packet includes an address of next node along the route to the destination.

5. The method of claim 4, in which the report includes additional information about the links such as link quality, bit rate, packet loss rate, bit error rate, average and minimum and maximum delays.

6. The method of claim 1, further comprising:
communicating directly with a particular node when the particular node fails to send the report.

7. A wireless network of nodes configured to trace a route, comprising:
a tracer node configured to generate a trace packet, the trace packet including a source address and a destination address of a route;
a source node configured to forward the trace packet received from the tracer node along the route;
a destination node configured to receive the trace packet forwarded by the source node; and
means, in each node, for sending a report packet to the tracer node in response to receiving the trace packet.

8. The system of claim 7, in which the tracer node is a coordinator node.

9. The system of claim 7, in which the route includes intermediate nodes between the source node and the destination node.

10. The system of claim 7, in which the report packet includes an address of next node along the route.

11. The system of claim 10, in which the report includes information about link quality, bit rate, packet loss rate, bit error rate, average and minimum and maximum delays.

12. The system of claim 7, further comprising:
means for communicating directly with a particular node when the particular node fails to send the report.
